(19) United States
(12) Patent Application Publication
(10) Pub. No.: US 2023/0392927 A1
(43) Pub. Date: Dec. 7, 2023

(54) STABILITY ATTACHMENT FOR A SURVEYING STICK SYSTEM

(71) Applicant: Bill Bolinger, Creston, IA (US)

(72) Inventor: Bill Bolinger, Creston, IA (US)

(21) Appl. No.: 17/831,702

(22) Filed: Jun. 3, 2022

(51) Int. Cl. G01C 15/06

(52) U.S. Cl. CPC G01C 15/06

(57) ABSTRACT

The disclosure is directed to a surveying stick system The surveying stick system includes a surveying stick base and a stability attachment attached to the surveying stick. The stability attachment includes a body and a spike slidably extending from a bottom side of the body. When the spike is in a retracted position, the spike does not extend below a bottom of the surveying stick base. The spike slidably shifts into an extended position. When the spike is in the extended position, the spike extends below the bottom of the surveying stick.

### TECHNICAL FIELD

The disclosure relates to stability devices. More specifically, the disclosure relates to a stability attachment to be used with a surveying stick base.

### BACKGROUND

Surveyors often carry a large amount of equipment when capturing measurements. In addition to the surveying stick base and the theodolite attached to a top of the surveying stick base, the surveyor must additionally carry a container of surveying flags and a bipedal attachment to attempt to stabilize the surveying stick base. In addition to being cumbersome, the bipedal attachment is generally difficult to position with the surveying stick base, and the stability of the overall system is questionable. While the system may be stable when left completely untouched, bumps, wind, and shifting of the system when taking the measurements can lead to instability of the overall system.

### SUMMARY

In general, the disclosure is directed to a stability attachment for a surveying stick. The attachment includes a slidable, retractable spike that can be inserted into the ground. The attachment attaches to the surveying stick at a bottom portion of the stick such that the spike, when retracted does not fall below the bottom of the base of the surveying stick, and also such that, when extended, the spike extends below the bottom of the base of the surveying stick. This enables the spike to be inserted into the ground, providing added stability to the surveying stick base while in use without encumbering the user with additional, separate parts that must be carried around.

To further assist the user, the attachment may be hollowed out such that a top compartment is available to place one or more surveying flags. By carrying the surveying flags, the surveying stick system itself would be heavier, providing added stability, while also further unencumbering the user by allowing the user to transport the surveying stick without additionally, and separately, having to carry a container of surveying flags. Overall, the system may reduce a number of separate parts that must be carried by a user from at least three separate parts to a single part, while also improving the stability technology of the surveying stick system.

In one example, the disclosure is directed to a surveying stick system that includes a surveying stick base and a stability attachment attached to the surveying stick. The stability attachment includes a body and a spike slidably extending from a bottom side of the body. When the spike is in a retracted position, the spike does not extend below a bottom of the surveying stick base. The spike slidably shifts into an extended position. When the spike is in the extended position, the spike extends below the bottom of the surveying stick.

In another example, the disclosure is directed to a stability attachment for a surveying stick system, the stability attachment including a body and a spike slidably extending from a bottom side of the body. The spike slidably shifts from a retracted position to an extended position.

In another example, the disclosure is directed to a method of capturing surveying measurements, the method including attaching a stability attachment to a surveying stick base, wherein the stability attachment comprises a body and a spike slidably extending from a bottom side of the body. The method further includes placing the surveying stick base at a location to be surveyed. The method also includes sliding the spike from a retracted position to an extended position, the extended position placing the spike into a ground surface at the location to be surveyed to provide stabilization to the surveying stick base. The method further includes capturing, using a theodolite attached to the surveying stick base, the surveying measurements.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

The following drawings are illustrative of particular examples of the present disclosure and therefore do not limit the scope of the invention. The drawings are not necessarily to scale, though examples can include the scale illustrated, and are intended for use in conjunction with the explanations in the following detailed description wherein like reference characters denote like elements. Examples of the present disclosure will hereinafter be described in conjunction with the appended drawings.

FIG. 1 is a conceptual diagram illustrating a perspective view of a surveying stick system with a surveying stick base and a stability attachment, in accordance with the descriptions and devices described herein.

FIG. 2 is a conceptual diagram illustrating a front view of a surveying stick system with a surveying stick base and a stability attachment with an extension spring, in accordance with the descriptions and devices described herein.

FIG. 3 is a conceptual diagram illustrating a front view of a surveying stick system with a surveying stick base and a stability attachment with an extension spring, in accordance with the descriptions and devices described herein.

### DETAILED DESCRIPTION

The following detailed description is exemplary in nature and is not intended to limit the scope, applicability, or configuration of the techniques or systems described herein in any way. Rather, the following description provides some practical illustrations for implementing examples of the techniques or systems described herein. Those skilled in the art will recognize that many of the noted examples have a variety of suitable alternatives.

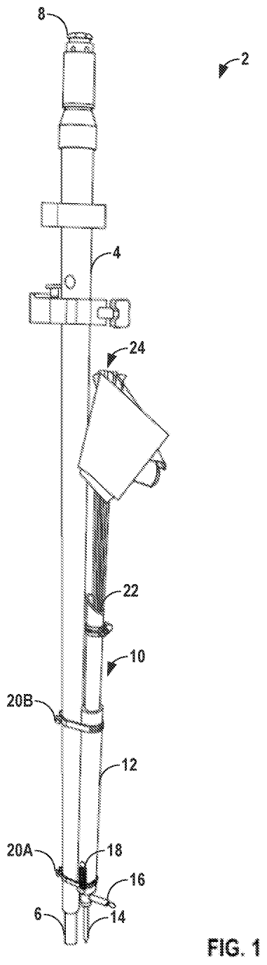

FIG. 1 is a conceptual diagram illustrating a perspective view of surveying stick system 2 with a surveying stick base 4 and stability attachment 10, in accordance with the descriptions and devices described herein. Surveying stick base 4 may be any surveying stick or surveying rod that can be used with various surveying tools. Surveying stick base 4 may be any typical material, including fiberglass, aluminum, plastic, or other lightweight yet sturdy material. Surveying stick base 4 may also include device hookup 8, where a user may install various surveying devices, such as theodolite device, onto a top of surveying stick base 4. Surveying stick base 4 may also include foot 6, which may be placed on the ground at a location where the user wishes to gather surveying measurements or data. While stability attachment 10 may provide added stability to surveying stick system 2, stability attachment 10 may also be used with bipedal attachments that turn surveying stick system 2 into a tripod type system in instances where stability is especially important.

In accordance with the devices and techniques described herein, surveying stick system 2 may also include stability attachment 10, which attaches to surveying stick base 4 using attachment mechanisms 20A and 20B. Stability attachment 10 is only an example of stability attachment 10, and other examples of stability attachment 10 that include additional pieces or fewer pieces are also contemplated herein. For instance, an example stability attachment 10 may not include pedal 16, or may not include compartment 22 to hold surveying flags 24. In other examples stability attachment 10 may further include a compression spring, a locking mechanism to keep spike 14 in either a retracted position or an extended position, or an additional compartment to carry additional surveying equipment.

Stability attachment 10, in the example of FIG. 1, includes body 12. Body 12 may be made from a similar material as surveying stick base 4, such as plastic, fiberglass, aluminum, or other material suitable for the purpose of providing a stability attachment to surveying stick base 4.

Stability attachment 10 further includes spike 14 slidably extending from a bottom side of body 12. Spike 14 may be made of any material capable of piercing a ground surface and staying put in the ground surface, such as a metal or a hard plastic. When spike 14 is in a retracted position, as shown in FIG. 1, spike 14 does not extend below foot 6 of surveying stick base 4. Spike 14 may slidably shift into an extended position, sliding out of the bottom of body 12 while body 12 remains stationary. When spike 14 is in the extended position, spike 14 may extend below the bottom of surveying stick base 4. This enables spike 14 to be inserted into the ground, providing added stability to surveying stick base 4 while in use without encumbering the user with additional, separate parts that must be carried around.

In some instances, stability attachment 10 further includes compartment 22. Compartment 22 may be accessible through a top portion of body 12 of stability attachment 10. In the example of FIG. 1, compartment 22 may be shaped and sized such that compartment 22 may receive one or more surveying flags 24.

By carrying the surveying flags, surveying stick system 2 itself would be heavier, providing added stability, while also further unencumbering the user by allowing the user to transport surveying stick system 2 without additionally, and separately, having to carry a container of surveying flags 24. Overall, surveying stick system 2 may reduce a number of separate parts that must be carried by a user from at least three separate parts to a single part, while also improving the stability technology of surveying stick system 2 with the inclusion of stability attachment 10.

In some instances, stability attachment 10 further includes one or more attachment mechanisms 20A and 20B to removably attach stability attachment 10 to surveying stick base 4. As shown in FIG. 1, attachment mechanisms 20A and 20B may be hose clamp systems. In other examples, attachment mechanisms 20A and 20B may be one or more of a buckle and strap system, a clip and strap system, a hook-and-loop strap system, a hinged compression mechanism, a mast clamp system, and a molded clip system.

In some instances, stability attachment 10 may further include spring 18 that applies force to spike 14. In the example of FIG. 1, spring 18 is an extension spring. In this example, extension spring 18 is in a resting position when spike 14 is in a retracted position. Extension spring 18 extends as the spike slidably shifts into the extended position, thereby applying pressure to spike 14. Extension spring 18, when extended, generates a first force that is less than a force needed to retract spike 14 from a ground surface penetrated by spike 14. In this way, when spike 14 is inserted into the ground, extension spring 18 does not apply enough force to remove spike 14 from the ground, enabling spike 14 to stay in place and stabilize surveying stick system 2. Furthermore, the first force is greater than a force needed to slidably shift spike 14 from the extended position into the retracted position when spike 14 is removed from the ground surface. In other words, extension spring 18 is specifically selected and calibrated, based on the specific materials used, such that the force exerted by extension spring 18 when in the extended position is enough to bring spike 14 back into the retracted position above the bottom of foot 6 when spike 14 is not inserted into the ground, but not enough force to remove spike 14 from a ground surface when spike 14 is in the extended position and inserted into the ground surface. In this way, spike 14 may stay retracted during transport, increasing the safety and reliability of surveying stick system 2, while maintaining the integrity of spike 14 while spike 14 is inserted into a ground surface.

In other instance, spring 18 may be a compression spring. In such instances, the compression spring is in a resting position when the spike is in a retracted position. The compression spring may compress as spike 14 slidably shifts into the extended position, thereby applying force to spike 14. The compression spring, when compressed, generates a first force that is less than a force needed to retract spike 14 from a ground surface penetrated by spike 14. In this way, when spike 14 is inserted into the ground, the compression spring does not apply enough force to remove spike 14 from the ground, enabling spike 14 to stay in place and stabilize surveying stick system 2. Furthermore, the first force is greater than a force needed to slidably shift spike 14 from the extended position into the retracted position when spike 14 is removed from the ground surface. In other words, the compression spring is specifically selected and calibrated, based on the specific materials used, such that the force exerted by the compression spring, when spike 14 is in the extended position, is enough to bring spike 14 back into the retracted position above the bottom of foot 6 when spike 14 is not inserted into the ground, but not enough force to remove spike 14 from a ground surface when spike 14 is in the extended position and inserted into the ground surface. In this way, spike 14 may stay retracted during transport, increasing the safety and reliability of surveying stick system 2, while maintaining the integrity of spike 14 while spike 14 is inserted into a ground surface.

In addition to or in place of spring 18, surveying stick system 2 may include a locking mechanism. The locking mechanism may be configured to lock spike 14 in either an extended position or a retracted position. In these examples, when spring 18 is still included with the locking mechanism, spring 18, be it a compression spring or an extension spring, may generate enough force to remove spike 14 from a ground surface when spike 14 is in the extended position. However, the locking mechanism may be the component that keeps spike 14 from being removed from the ground, with the user activating the locking mechanism upon sliding spike 14 into the extended position. Similarly, the locking mechanism, when activated, may restrict spike 14 from moving from the retracted position into the extended position. Deactivating the locking mechanism may enable the user to slide spike 14 between the retracted and extended positions. The locking mechanism may be any of a push tab system, a pin system, a clamp system, a push button system, a pressure system, or any other mechanism suitable for locking telescoping tubes into place.

In some instances, stability attachment 10 includes pedal 16. Pedal 16 may be an extension off of body 12 or spike 14 that enables a user to push spike 14 into a ground surface with a foot or a hand. Pedal 16 may provide the user with added leverage in order to provide adequate force to pierce the ground surface effectively.

In accordance with the techniques described herein, to install surveying stick system 2 in place for the purpose of capturing surveying measurements, a user may attach stability attachment 10 to surveying stick base 4 using attachment mechanisms 20A and 20B. The user may place surveying stick base at a location to be surveyed, placing foot 6 on a ground surface at the location. The user may slide spike 14 from a retracted position to an extended position, such as by pushing on, or applying force to, pedal 16 with a hand or a foot, with the extended position placing spike 14 into the ground surface at the location to be surveyed to provide stabilization to surveying stick base 4. The user may then capture the surveying measurements with any proper tools, such as using a theodolite attached to surveying stick base 4 at device hookup 8. After capturing the surveying measurements, the user may retract spike 14 out of the ground surface and back into the retracted position.

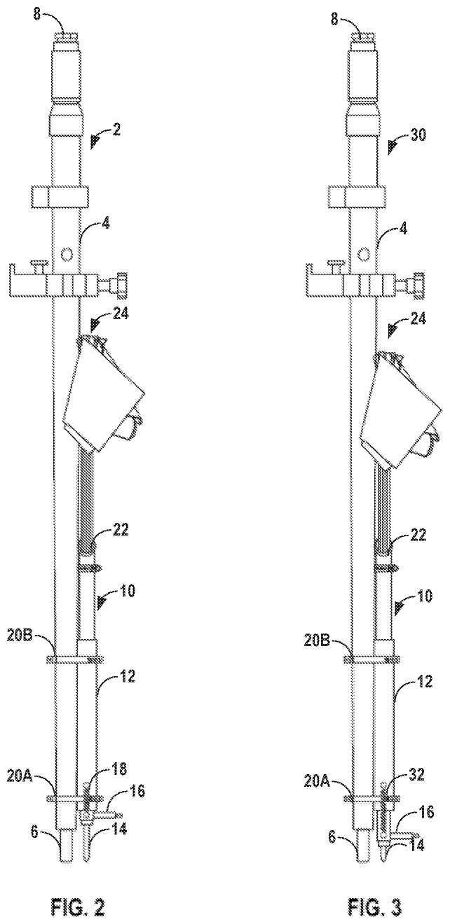

FIG. 2 is a conceptual diagram illustrating a front view of surveying stick system 2 with surveying stick base 4 and stability attachment 10 with extension spring 18, in accordance with the descriptions and devices described herein. As with FIG. 1, the example surveying stick system 2 of FIG. 2 includes surveying stick base 4 with foot 4 and device hookup 8. Stability attachment 10 includes body 12, spike 14, pedal 16, attachment mechanisms 20A and 20B, compartment 22, and surveying flags 24. In the example of FIG. 2, stability attachment 10 includes extension spring 18.

In this example, extension spring 18 is in a resting position when spike 14 is in a retracted position. Extension spring 18 extends as the spike slidably shifts into the extended position, thereby applying pressure to spike 14. Extension spring 18, when extended, generates a first force that is less than a force needed to retract spike 14 from a ground surface penetrated by spike 14. In this way, when spike 14 is inserted into the ground, extension spring 18 does not apply enough force to remove spike 14 from the ground, enabling spike 14 to stay in place and stabilize surveying stick system 2. Furthermore, the first force is greater than a force needed to slidably shift spike 14 from the extended position into the retracted position when spike 14 is removed from the ground surface. In other words, extension spring 18 is specifically selected and calibrated, based on the specific materials used, such that the force exerted by extension spring 18 when in the extended position is enough to bring spike 14 back into the retracted position above the bottom of foot 6 when spike 14 is not inserted into the ground, but not enough force to remove spike 14 from a ground surface when spike 14 is in the extended position and inserted into the ground surface.

FIG. 3 is a conceptual diagram illustrating a front view of a surveying stick system with a surveying stick base and a stability attachment with an extension spring, in accordance with the descriptions and devices described herein. As with FIG. 1, the example surveying stick system 30 of FIG. 3 includes surveying stick base 4 with foot 4 and device hookup 8. Stability attachment 10 includes body 12, spike 14, pedal 16, attachment mechanisms 20A and 20B, compartment 22, and surveying flags 24. In the example of FIG. 3, stability attachment 10 includes compression spring 32.

In such instances, compression spring 32 is in a resting position when spike 14 is in a retracted position. Compression spring 32 may compress as spike 14 slidably shifts into the extended position, thereby applying force to spike 14. Compression spring 32, when compressed, generates a first force that is less than a force needed to retract spike 14 from a ground surface penetrated by spike 14. In this way, when spike 14 is inserted into the ground, compression spring 32 does not apply enough force to remove spike 14 from the ground, enabling spike 14 to stay in place and stabilize surveying stick system 2. Furthermore, the first force is greater than a force needed to slidably shift spike 14 from the extended position into the retracted position when spike 14 is removed from the ground surface. In other words, compression spring 32 is specifically selected and calibrated, based on the specific materials used, such that the force exerted by compression spring 32, when spike 14 is in the extended position, is enough to bring spike 14 back into the retracted position above the bottom of foot 6 when spike 14 is not inserted into the ground, but not enough force to remove spike 14 from a ground surface when spike 14 is in the extended position and inserted into the ground surface. In this way, spike 14 may stay retracted during transport, increasing the safety and reliability of surveying stick system 2, while maintaining the integrity of spike 14 while spike 14 is inserted into a ground surface.

As shown in FIG. 3, spike 14 may be varying in size while still adhering to the devices described herein. In the example of FIG. 3, spike 14 is shorter in length than spike 14 of FIGS. 1 and 2. However, in other examples, spike 14 may be of similar length, or of a longer length than spike 14 of FIGS. 1 and 2. In any instance of stability attachment 10 described herein, spike 14 may have a varying length to accommodate different conditions, such as different ground material or wind conditions.

Various examples of the disclosure have been described. Any combination of the described systems, operations, or functions is contemplated. These and other examples are within the scope of the following claims.

What is claimed is:

1. A surveying stick system comprising:
a surveying stick base; and
a stability attachment attached to the surveying stick, the stability attachment comprising:
a body; and
a spike slidably extending from a bottom side of the body,
wherein, when the spike is in a retracted position, the spike does not extend below a bottom of the surveying stick base,
wherein the spike slidably shifts into an extended position, and
wherein, when the spike is in the extended position, the spike extends below the bottom of the surveying stick base.

2. The surveying stick system of claim 1, wherein the stability attachment further comprises a compartment, accessible through a top portion of the body of the stability attachment, that receives one or more surveying flags.

3. The surveying stick system of claim 1, wherein the stability attachment further comprises one or more attachment mechanisms to removably attach the stability attachment to the surveying stick base.

4. The surveying stick system of claim 3, wherein each of the one or more attachment mechanisms comprise one or more of:
a buckle and strap system,
a clip and strap system,
a hook-and-loop strap system,
a hinged compression mechanism,
a hose clamp system,
a mast clamp system, and
a molded clip system.

5. The surveying stick system of claim 1, wherein the stability attachment further comprises a spring that applies force to the spike.

6. The surveying stick system of claim 5, wherein the spring comprises a compression spring,
wherein the compression spring is in a resting position when the spike is in a retracted position,
wherein the compression spring compresses as the spike slidably shifts into the extended position,
and wherein the compression spring, when compressed, generates a first force that is less than a force needed to retract the spike from a ground surface penetrated by the spike, and wherein the first force is greater than a force needed to slidably shift the spike from the extended position into the retracted position when the spike is removed from the ground surface.

7. The surveying stick system of claim 5, wherein the spring comprises an extension spring,
wherein the extension spring is in a resting position when the spike is in a retracted position,
wherein the extension spring extends as the spike slidably shifts into the extended position,
and wherein the extension spring, when extended, generates a first force that is less than a force needed to retract the spike from a ground surface penetrated by the spike, and wherein the first force is greater than a force needed to slidably shift the spike from the extended position into the retracted position when the spike is removed from the ground surface.

8. The surveying stick system of claim 1, wherein the stability attachment further comprises a pedal attached to the spike.

9. The surveying stick system of claim 1, further comprising a secondary bipedal attachment attached to the surveying stick base.

10. A stability attachment for a surveying stick system, the stability attachment comprising:
a body; and
a spike slidably extending from a bottom side of the body,
wherein the spike slidably shifts from a retracted position to an extended position.

11. The stability attachment of claim 10, wherein the stability attachment further comprises a compartment, accessible through a top portion of the body of the stability attachment, that receives one or more surveying flags.

12. The stability attachment of claim 10, wherein the stability attachment further comprises one or more attachment mechanisms to removably attach the stability attachment to the surveying stick base.

13. The stability attachment of claim 12, wherein each of the one or more attachment mechanisms comprise one or more of:
a buckle and strap system,
a clip and strap system,
a hook-and-loop strap system,
a hinged compression mechanism,
a hose clamp system,
a mast clamp system, and
a molded clip system.

14. The stability attachment of claim 10, wherein the stability attachment further comprises a spring that applies force to the spike.

15. The stability attachment of claim 14, wherein the spring comprises a compression spring,
wherein the compression spring is in a resting position when the spike is in a retracted position,
wherein the compression spring compresses as the spike slidably shifts into the extended position,
and wherein the compression spring, when compressed, generates a first force that is less than a force needed to retract the spike from a ground surface penetrated by the spike, and wherein the first force is greater than a force needed to slidably shift the spike from the extended position into the retracted position when the spike is removed from the ground surface.

16. The stability attachment of claim 14, wherein the spring comprises an extension spring,
wherein the extension spring is in a resting position when the spike is in a retracted position,
wherein the extension spring extends as the spike slidably shifts into the extended position,
and wherein the extension spring, when extended, generates a first force that is less than a force needed to retract the spike from a ground surface penetrated by the spike, and wherein the first force is greater than a force needed to slidably shift the spike from the extended position into the retracted position when the spike is removed from the ground surface.

17. The stability attachment of claim 10, wherein the stability attachment further comprises a pedal attached to the spike.

18. The stability attachment of claim 10, further comprising a locking mechanism that, when activated, restricts the spike from sliding between the retracted position and the extended position.

19. A method of capturing surveying measurements, the method comprising:
attaching a stability attachment to a surveying stick base, wherein the stability attachment comprises a body and a spike slidably extending from a bottom side of the body;
placing the surveying stick base at a location to be surveyed;
sliding the spike from a retracted position to an extended position, the extended position placing the spike into a ground surface at the location to be surveyed to provide stabilization to the surveying stick base;
capturing, using a theodolite attached to the surveying stick base, the surveying measurements.

20. The method of claim 18, wherein sliding the spike into the ground surface comprises applying force to a pedal attached to the spike to slide the spike from the retracted position to the extended position,
and wherein the method further comprises, after capturing the surveying measurements, retracting the spike out of the ground surface and back into the retracted position.
